(19) United States
(12) Patent Application Publication
(10) Pub. No.: US 2007/0006295 A1
(43) Pub. Date: Jan. 4, 2007

(54) Adaptive IPsec processing in mobile-enhanced virtual private networks

(76) Inventors: Henry Haverinen, Jyvaskyla (FI); Sandro Grech, Helsinki (FI); Pasi Eronen, Helsinki (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 11/472,996

(22) Filed: Jun. 23, 2006

(30) Foreign Application Priority Data
Jun. 24, 2005 (EP) 05 013 700.9

(51) Int. Cl. G06F 15/16

(52) U.S. Cl. 726/14

(57) ABSTRACT

Disclosed is a method providing secure mobility for a terminal in a mobile system comprising at least two IP based sub-networks. The method comprises to detect a change of the IP based sub-network by the terminal. The connection parameters of the terminal are updated so as to be connected with a new IP based sub-network. Further, the security requirements of the new IP based sub-network are detected, and the security associations of the terminal to the new IP based sub-network are adapted to the security requirements of the new IP based sub-network.

### FIELD OF THE INVENTION

The present invention relates to a method providing secure mobility for a terminal in a virtual private network comprising at least two IP based sub-networks. The present invention further relates to a system, a gateway node and a terminal configured to perform this method.

### RELATED BACKGROUND ART

In recent years, one research focus was on mobile virtual private networks (VPN), which support an IPsec (secure Internet Protocol) based remote-access VPN operation with mobility.

A use-case of a mobile virtual private network is e.g. to provide mobility between a trusted enterprise intranet and an external not trusted network, including to provide mobility across security boundaries. Also, a mobile virtual private network may involve several bearer technologies, such as GPRS, circuit-switched data, wireless LAN, Bluetooth etc. Hence, mobility between the different bearers and Mobile IP should be provided, including that upcoming terminal devices would have to be accordingly configured. In the intranet access case, some of the access methods may require the use of bi-directional encrypted tunneling (as in Virtual Private Network (VPN) remote access techniques), because the access networks are not trusted (for example public access networks), while other access methods do not require encrypted tunneling, because the access technique supports link-layer encryption and the access networks are trusted (such as intranet Wi-Fi protected access networks).

An IPsec-based security can also be applied in the mobile operator environment. The 3^{rd} generation partnership project (3GPP) has specified the WLAN 3GPP IP Access scenario in the Technical Specification 33.234. In this scenario, the terminal and a Packet Data Gateway (PDG) hosted by a mobile operator establish an IPsec tunnel so that the terminal can access an IP network that is “behind” the PDG. An example of the IP network is a service network that contains application servers for operator services, such as the IP Multimedia Subsystem (IMS). The IPsec tunnel according to WLAN 3 GPP IP Access might be used when the terminal is attached to the network in a Wireless LAN access network that is not trusted by the operator. The terminal may be able to reach the same services over some other types of access networks, such as the General Packet Radio Service (GPRS), or other types of Wireless LAN networks, which might be trusted by the operator. When using a GPRS connection or a trusted Wireless LAN access network, the operator might consider the layer-2 security of the GPRS system to provide a sufficient level of security so that IPsec protection is not needed over GPRS.

One example of the research on mobile VPN is the work of the IETF MOBIKE working group (http://www.ietf.org/html.charters/mobike-charter.html) which aims at standardizing mobility extensions for the Internet Key Exchange (IKE) protocol. IKE mobility extensions allow a client to change its local IP address and yet maintain the same VPN session.

Alternatively to IKE mobility extensions, it is possible to run VPN protocols over Mobile IP, or to use an IPsec processing for Mobile IP tunnels. When a VPN solution is run over Mobile IP, the VPN client only sees the Mobile IP home address. Mobile IP hides the mobility from the VPN software. In the terminal protocol stack, the Mobile IP protocols are below the VPN protocols.

The Mobile IPv6 protocol specifies how IPsec processing can be applied to bi-directional tunnels between a Mobile node and a home agent. In this case, the Mobile IPv6 protocol is used as a combined mobility and security solution, as Mobile IP tunnels are processed with IPsec transformations. Although it is presently not specified by the IETF Mobile IP standards, it seems to be also possible to use similar techniques with the Mobile IPv4 protocol.

When IKE mobility extensions are used, or when running IPsec protocols in conjunction with a single layer of Mobile IP, it is possible to move between networks that have different security properties. However, the currently known IKE mobility techniques do not allow taking the security properties of the currently visited network into account when choosing the IPsec cipher suites. Hence, the required IPsec processing has to be selected according to the least secure network. For example, when moving across a security boundary from a not trusted network to a trusted network, in IKE mobility or when running a single instance of Mobile IP, it is not possible to avoid the overhead of IPsec encryption and integrity protection when using IKE mobility extensions, or when running VPN protocols over Mobile IP, or when applying IPsec processing to Mobile IP tunnels.

But, to avoid the IPsec processing when moving to a trusted network across a security boundary is known in the art. That is, the Internet-Draft draft-ietf-mobileip-vpn-problem-solution-03.txt presents a solution, which is based on two Mobile IP layers. In this solution, IPsec processing is not needed when using a trusted access network. However, this solution requires two home agents and a separate VPN gateway (i.e. three special router in total), and the tunneling configuration changes depending on the network, so that this prior art solution is considerably complex and incurs a high overhead. According to this Internet-Draft, IPsec processing is avoided, because two separate Mobile IP protocol layers are used, and separate signaling procedures are used for internal and external mobility.

FIG. 3 shows an example of a terminal protocol stack according to the prior art involving a double mobile IP solution. When IPsec processing is not needed, then the upper Mobile IP layer may directly connect to network interfaces so that the IPsec layer and the lower Mobile IP layer are by-passed. However, this involves a lot of complexity and tunneling overhead. In these terminal stacks, “network interface 1” and “network interface 2” represent the network interfaces of the terminal. They may include WLAN, GPRS, WiMAX, Bluetooth, USB, Ethernet etc.

FIG. 4 shows another example of a terminal protocol stack according to the prior art, this time involving an IPsec over Mobile IP solution. In this implementation, IPsec is always used and it is always run over Mobile IP. Here, it is not possible to skip IPsec processing.

FIG. 5 shows still another example of a terminal protocol stack according to the prior art involving Mobile IP with encrypted tunnels. Also in this implementation, IPsec processing is always used. It is not possible to skip or adapt IPsec processing.

FIG. 6 shows an example of a terminal protocol stack according to the prior art involving a MOBIKE solution. In this implementation, IPsec is always used and the security policy does not change depending on a network interface or location.

It is to be noted in general that some mobile devices need to apply IPsec in order to access certain services over certain “insecure” access methods, while on the other hand IPsec is not required to access the same services over the “secure” access methods. In mobile operator networks, an example for an “insecure” access method could be a public WLAN hot-spot providing access to operator services over a public network (e.g. Internet). An example of a “secure” access method could be GPRS with layer 2 encryption enabled. In enterprise networks, an example for an “insecure” access method could be a remote access to a corporate network over the public Internet. An example of a “xsecure” access methgod could be a Wi-Fi Protected Access (WPA) network attached to the trusted part of a corporate network.

When switching across trusted and untrusted access methods the mobile device will need to dynamically switch IPsec on or off according to the security policies. However, in practice this incurs additional handover delays, while performing the IKE signaling. In the worst case, a user intervention may also be required in order to supply the authentication credentials (e.g. using SecurID). One approach to avoid this additional handover delay could be to apply IPsec over all access methods. However, this often incurs an unacceptable overhead (e.g. over resource-limited links such as GPRS) and gateway capacity requirements, since all traffic would need to be processed by IPsec gateways.

### SUMMARY OF THE INVENTION

It is an object of the present invention to overcome the shortcomings of the prior art.

One aspect of the present invention is a method providing secure mobility for a terminal in a mobile system comprising at least two IP based sub-networks, comprising detecting a change of the IP based sub-network by the terminal; updating the connection parameters of the terminal so as to be connected with a new IP based sub-network; detecting security requirements of the new IP based sub-network; and adapting security associations of the terminal to the new IP based sub-network to the security requirements of the new IP based sub-network.

Advantageously, this method may be modified, wherein the step of updating includes using Internet key exchange mobility extensions for updating an IP address of the terminal; the step of detecting security requirements includes detecting either by the terminal or by a gateway node that security properties of the new IP based sub-network and an old IP based sub-network are different, and initiating a re-negotiation of security associations according to the secure Internet Protocol using the Internet key exchange protocol; and the step of adapting includes adapting either by the terminal or the gateway node a list of allowed cipher suites according to the security properties of the new IP based sub-network, and selecting a new cipher suite according to an adaptation of a secure Internet Protocol processing to the security properties of the new IP based sub-network.

Alternatively, the method according to the first aspect of the present invention may be modified, wherein the step of updating includes performing a Mobile IP registration; the step of detecting includes receiving indications in Mobile IP registration message extensions about allowed security associations and required security processing in the new IP based sub-network; and the step of adapting includes adapting the security processing according to the secure Internet Protocol based on the Mobile IP registration message extensions.

Furthermore, the method according to the first aspect of the present invention may be modified by comprising the consecutive steps of negotiating an IPsec session with an IPsec gateway node by the terminal while the terminal is located in a trusted network; detecting security requirements of an untrusted network; detecting a change of an IP based sub-network by the terminal, wherein the change is from trusted access to untrusted access; updating connection parameters of the terminal so as to be connected with a new IP based sub-network providing untrusted access; and adapting security associations of the terminal connected to the new IP based sub-network to the security requirements of the new IP based sub-network including informing the IPsec gateway node of a change in an IP address of the terminal and enabling IPsec for all traffic.

According to a second aspect of the present invention, there is provided a system including a terminal and a mobile system comprising at least two IP based sub-networks and a gateway node, wherein the system is configured to perform the method according to the first aspect or any of its modifications.

According to a third aspect of the present invention, there is provided a gateway node of a mobile system which is configured to perform the method according to the first aspect or any of its modifications.

According to a fourth aspect of the present invention, there is provided a terminal capable of changing connection between IP based sub-networks of a mobile system and being configured to perform the method according to the first aspect or any of its modifications.

A fifth aspect of the present invention is a computer program product comprising processor implementable instruction portions for performing all the steps of the method according to the first aspect or any of its modifications.

This computer program product may be modified to comprise a software medium storing said processor implementable instruction portions.

Also, this computer program product may be modified to be directly loadable into the internal memory of a computer.

A sixth aspect of the present invention is a signal carrying processor implementable instructions for controlling a computer to carry out all the steps of the method according to the first aspect or any of its modifications.

Accordingly, one advantage of the present invention is that the same signaling protocol and the same protocol stacks can be used, and a single router can manage the mobility of the terminal, regardless of the location of the terminal.

Further, when MOBIKE is used, according to the present invention a VPN feature is added which is easy to implement rather than to provide a completely new system. That is, in addition to the IKE mobility extensions there is no excessive amount of implementation required. For example, no new credentials or authentication infrastructure is needed.

On the other hand, if the present invention is implemented without using MOBIKE, even fast mobility such as Mobile IP fast handoffs can be supported.

Still further, according to the present invention the overhead of IPsec processing can be adapted according to the security properties of the current network. In some cases null encryption and null integrity protection can be used, so that the VPN tunnel can only be used for mobility.

Thus, the present invention provides a well feasible solution regardless whether the internal network deploys Mobile IP or not.

### BRIEF DESCRIPTION OF THE DRAWINGS

Further effects, advantages and features of the present invention will become apparent from the following description of the preferred embodiments thereof which are to be taken in conjunction with the appended drawings, in which:

FIG. 1 shows the principle system underlying the present invention;

FIG. 2 shows the method according to the present invention;

FIG. 3 shows an example of a terminal protocol stack according to the prior art involving a double mobile IP solution;

FIG. 4 shows another example of a terminal protocol stack according to the prior art involving an IPsec over Mobile IP solution;

FIG. 5 shows still another example of a terminal protocol stack according to the prior art involving Mobile IP with encrypted tunnels;

FIG. 6 shows an example of a terminal protocol stack according to the prior art involving a MOBIKE solution;

FIG. 7 shows an example of a terminal protocol stack according to the first embodiment of present invention without Mobile IP;

FIG. 8 shows an example of a gateway protocol stack according to the first embodiment of the present invention without Mobile IP;

FIG. 9 shows an example of a terminal protocol stack according to the first embodiment of the present invention involving an IPsec over Mobile IP solution; and

FIG. 10 shows an example of a terminal protocol stack according to the second embodiment of the present invention involving Mobile IP with encrypted tunnels.

### DESCRIPTION OF THE PREFERRED EMBODIMENTS

In the following, preferred embodiments of the present invention are described by referring to implementation examples thereof. These implementation examples serve to illustrate ways of carrying out the present invention, but are in no way intended to be limiting.

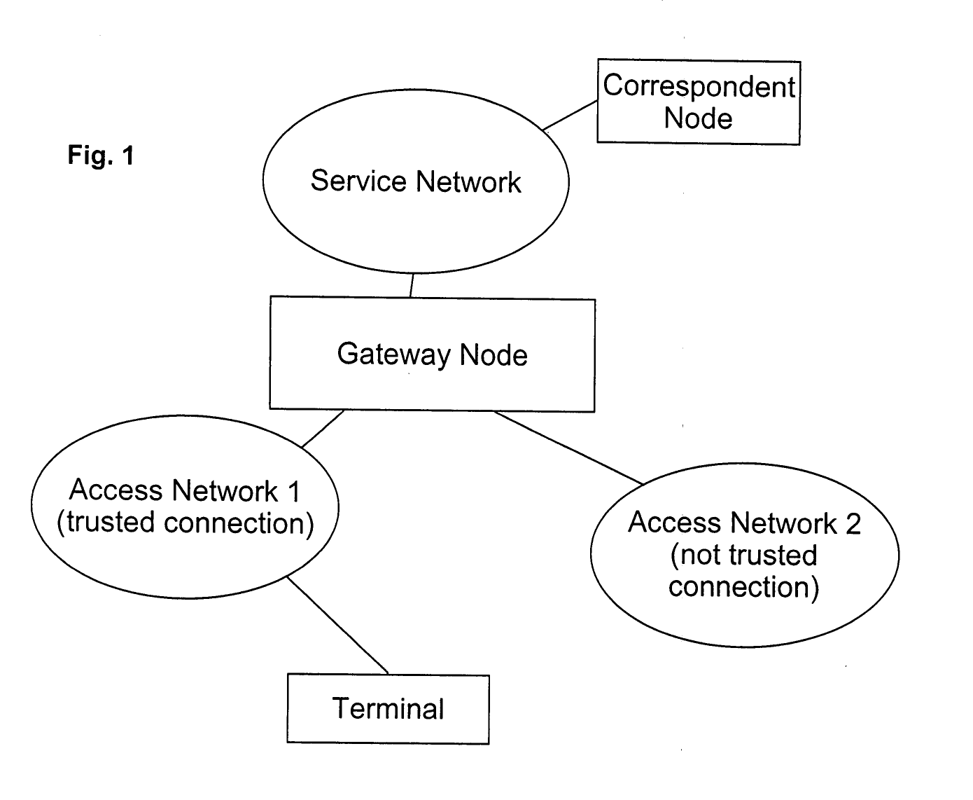

FIG. 1 shows the principle system underlying the present invention. Specifically, a terminal may be connected to an access network 1 via a trusted connection or to an access network 2 via a not trusted connection. Through a gateway node, the terminal thus may obtain connection to various correspondent nodes such as application server which are located in a service network. It is to be noted, however, that the service network may be the same as one of the access networks.

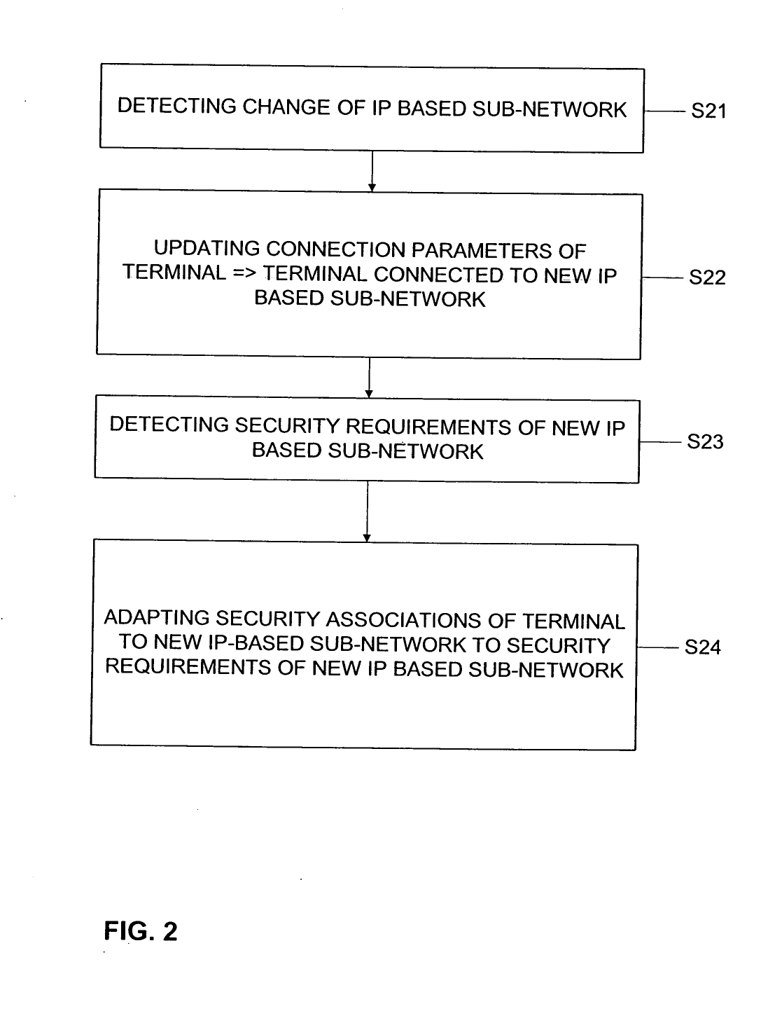

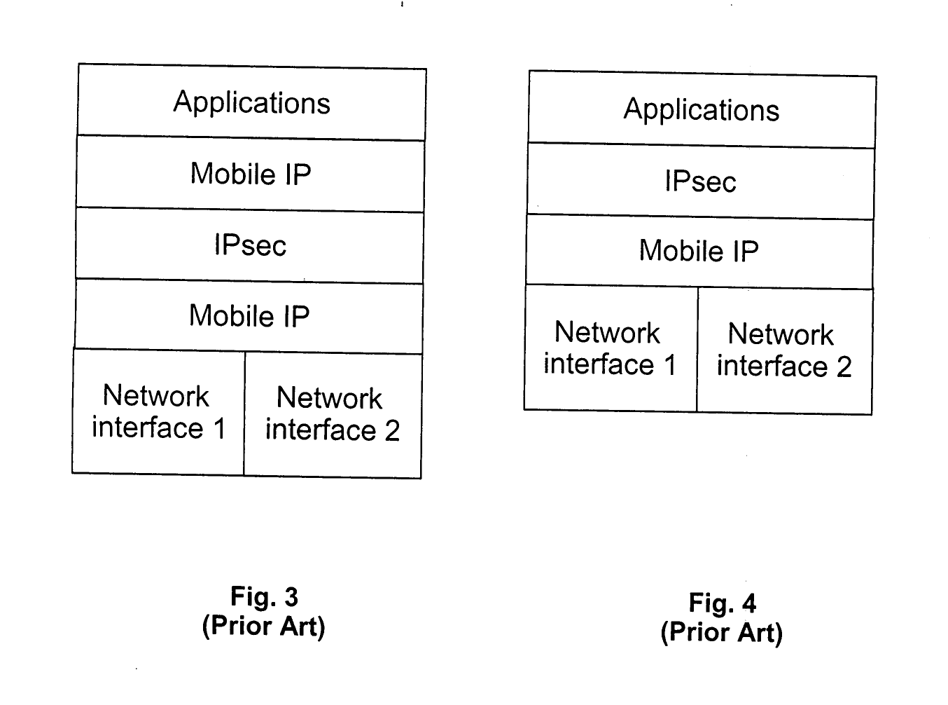

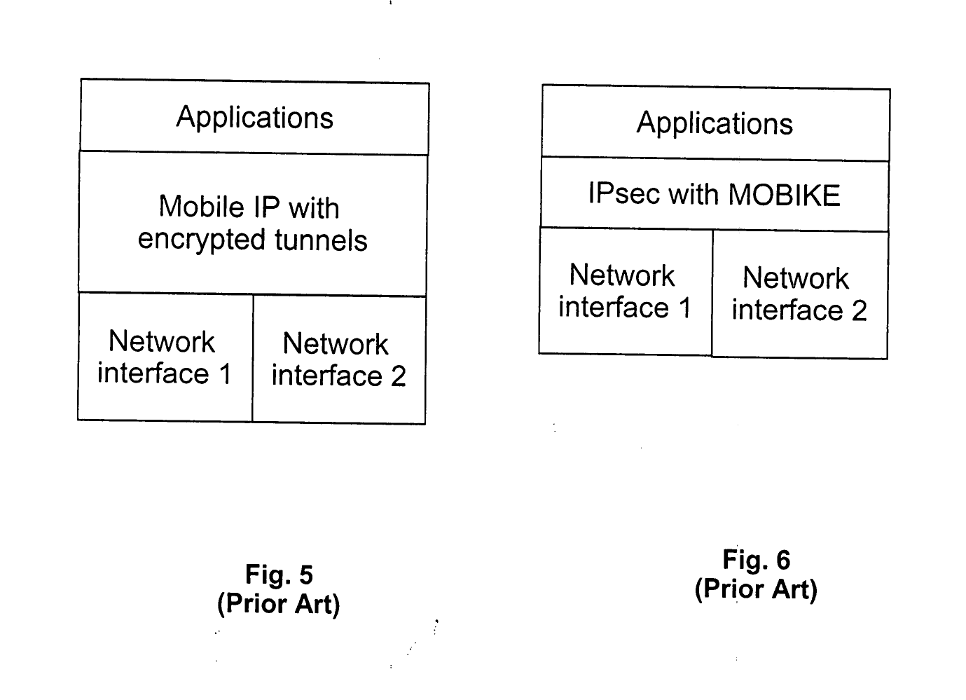

FIG. 2 shows the method according to the present invention. In detail, the method provides secure mobility for a terminal in a mobile system comprising at least two IP based sub-networks. In a step S21 a change of the IP based sub-network is detected by the terminal. In a step S22 the connection parameters of the terminal are updated so that the terminal is henceforth connected with a new IP based sub-network. Then, in a step S23, the security requirements of the new IP based sub-network are detected. Finally, the security associations of the terminal to the new IP based sub-network are adapted to the security requirements of the new IP based sub-network (step S24).

(First Embodiment)

According to a first embodiment of the present invention, cipher suite requirements in a mobile-enhanced IPsec VPN are adapted according to the characteristics of the current network. The first embodiment of the present invention includes that IKE is used to re-negotiate the cipher suite as described in the following.

Firstly, a terminal detects a change of the IP sub-network. Next, either Mobile IP or IKE mobility extensions are used to update the terminal's (client) IP address. Then, either the terminal or a VPN gateway node detects that the security properties of the new sub-network and of the old sub-network are different. For example, the new sub-network might provide sufficient security at a lower layer (such as a layer 2 encryption), while the old sub-network is not trusted. Thereafter, a re-negotiation of the IPsec security associations is initiated using the Internet Key Exchange (IKE) protocol. Depending on whether the security properties of the new sub-network are better or worse than the properties of the old sub-network, the node that detects the change in the security properties may allow or disallow continuing communications in the new sub-network while re-negotiating the security association. For example, when moving from a less trusted or less secure sub-network to a more secure or more trusted sub-network, it might be acceptable to continue communicating with the old cipher suite while re-negotiating a less secure and more effective cipher suite (such as null encryption). However, when performing a transition in the opposite direction, communications should not be continued while re-negotiating the security association. Finally, either the terminal or the gateway node adapts the list of allowed cipher suites according to the security properties of the new sub-network. For example, the gateway node could determine the security properties of the new sub-network based on out-of-band mechanisms such as the network interface by which the terminal communicates to the gateway node, or based on the terminal's new IP address. A new cipher suite is selected during the negotiation, so that the IPsec processing adapts to the security properties of the new network.

It is to be noted that in case Mobile IP extensions are used to update the terminal's (client) IP address, there needs to be an interface from the terminal's home agent to the Ipsec gateway so that the Ipsec gateway learns the current location of the terminal (for example, its care-of-address).

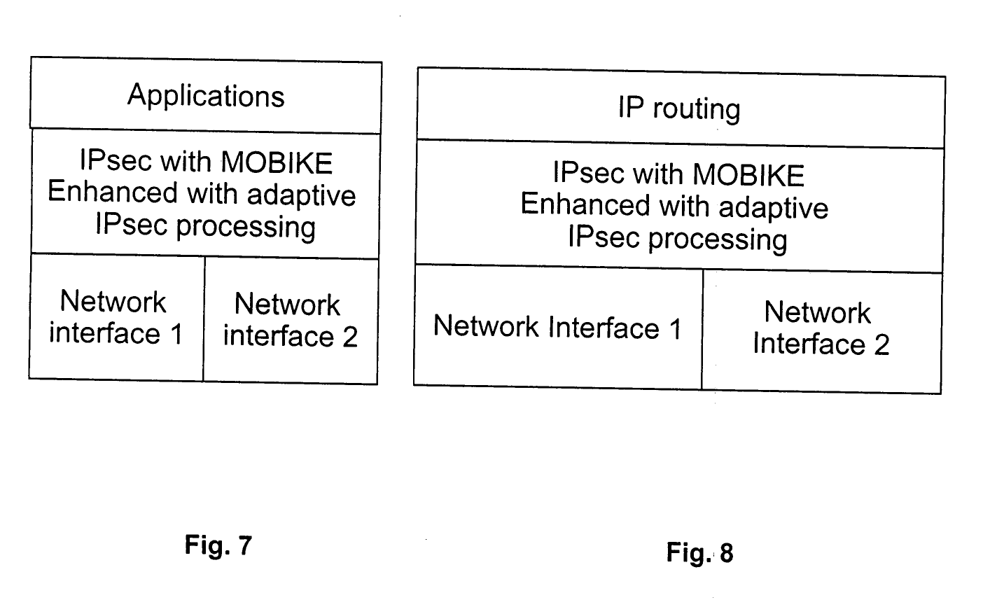

FIG. 7 shows an example of a terminal protocol stack according to the first embodiment of the present invention without Mobile IP. The IPsec processing adapts based on the network interface, the security parameters of the connection, the local IP address, or properties proposed by the gateway. The adaptation of the IPsec processing may also be implemented by the gateway, in which case the terminal does not implement any enhancements, but simply always accepts the processing proposed by the gateway.

FIG. 8 shows an example of a gateway protocol stack according to the first embodiment of the present invention without Mobile IP. In this case, the adaptation of the IPsec processing is implemented by the gateway. The adaptation may be chosen based on a network interface via which the terminal is connecting, the address of the gateway used by the terminal, or the terminal's local address. In these gateway stacks, “network interface 1” and “network interface 2” represent the network interfaces of the gateway. The gateway might have a separate network interface to the not trusted access networks, another network interface to the trusted access networks, and another network interface to the service network.

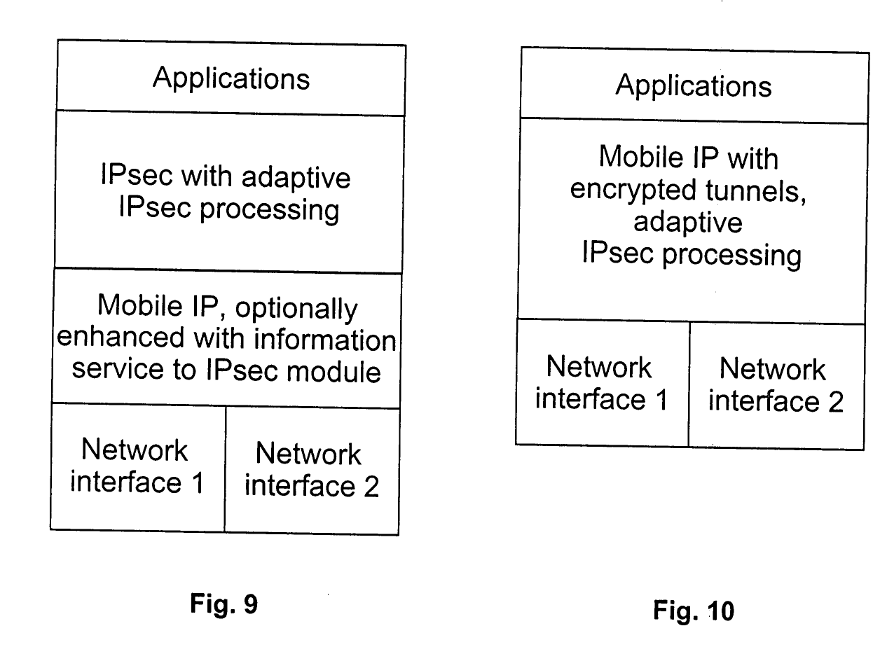

FIG. 9 shows an example of a terminal protocol stack according to the first embodiment of the present invention involving an IPsec over Mobile IP solution. The adaptation of IPsec processing is negotiated using Internet Key Exchange signaling, which can e.g. be based on information from the Mobile IP implementation of the terminal. The information needed for the adaptation may alternatively be provided to the IKE implementation of the gateway by the home agent so that Mobile IP enhancements in the terminal or an adaptation in the IPsec implementation of the terminal may not be needed.

(Second Embodiment)

According to a second embodiment of the present invention, Mobile IP is used for the mobility signaling so that it becomes possible to perform the security re-negotiation as part of the Mobile IP signaling (with a registration (IPv4) or binding update (IPv6) procedure).

Specifically, according to the second embodiment a terminal detects a change of the IP sub-network. Then, a Mobile IP registration procedure is performed. If Mobile IPv4 is used, then the terminal sends a “registration request” to the home agent, and the home agent responds with a “registration reply”. In Mobile IPv6, the corresponding messages are a “binding update” and “binding acknowledgment”. The Mobile IP registration messages are extended to include indications about the allowed security associations or the required security processing in the new sub-network. For example, the home agent can include an extension in the “registration reply” message to indicate the required level of security. It is also possible to allow route optimization only when the current access network (sub-network to the VPN) is trusted, but requires a bi-directional tunneling when the access network is not trusted. Finally, the IPsec processing is adapted based on the extensions exchanged during the Mobile IP registration.

It is to be noted that the cipher suite specifying what kind of security processing is required for the traffic may also change in the present embodiment. Also here, lists of allowed cipher suites could be transmitted.

Besides, another way to implement a change in the cipher suite in both the first and the second embodiment is to have predefined cipher suites for trusted and not trusted cases. Then, the protocol signaling only indicates whether the current network is not trusted or trusted.

FIG. 10 shows an example of a terminal protocol stack according to the second embodiment of the present invention involving Mobile IP with encrypted tunnels. The IPsec processing adapts based on the network interface, security parameters of the connection, the local (care-of) IP address, or properties proposed by the gateway. The adaptation is negotiated in a Mobile IP signaling.

(Third Embodiment)

As an optimization to the first and second embodiment, all the access-specific security associations are pre-negotiated upon initial connection setup, such that mobility is faster, since mobility only incurs selecting a new active security association. Typically, only a couple of different security policies are needed, so the pre-negotiation does not need to create very many security associations. Access networks are classified into groups that correspond to the pre-negotiated security associations. It is not necessary to know all possible access networks in advance, but it is sufficient to know all possible security policies. For example, two different types of security associations could be negotiated upon initial connection setup, so that the first type includes integrity protection and encryption, while the second type includes only integrity protection but does not include encryption.

(Examples for Security Detection)

In the above described embodiments, the detection of the security level can be effected according to the following examples.

### EXAMPLE 1

A first example for detecting the security level of a sub-network is that the detection is based on one or more of the following criteria.

The gateway node can have several IP addresses, i.e. an external address and an internal address. The gateway can also have separate network interfaces, one to the a public side (Internet) and one to an intranet. In this case, the gateway node detects whether the terminal's current connection is coming from the internal or external IP address, or from the external or internal network interface.

Further, if the gateway node has several IP addresses, then the terminal might also know which of the addresses are reachable from a trusted side. The addresses that are reachable from the trusted side should not be reachable from the external side. Hence, the terminal can allow a lower level of security only when it is communicating with one of the gateway IP addresses reserved for internal use in the trusted side.

Still further, the terminal can also detect that the current connection belongs to a preconfigured group of “trusted” connections. The connection group settings are managed either by an operator or by an enterprise. For example, a destination network identity parameter of an Internet access point (IAP) can indicate that the IAP is an “office” IAP that provides a direct connection to the Intranet. Typically, these trusted connections would have link-layer security, for example WiFi protected access security with mutual authentication, so that the terminal is able to ascertain that the current connetion is really one of the preconfigured trusted connections.

### EXAMPLE 2

Another example for detecting the security level of a sub-network is based on the assumption that Mobile IP is used as a “VPN” solution. During the Mobile IP registration (i.e. “binding update”, depending on the Mobile IP version), the home agent detects whether the mobile node is connected to a trusted access network or a not trusted access network.

Specifically, if the terminal (mobile node) is connected to a not trusted access network, then the home agent requires the terminal to use encrypted bi-directional tunneling. The home agent communicates this requirement to the mobile node as part of the Mobile IP registration procedure, such as in the “binding acknowledgment” (v6) or “registration reply” (v4) message.

If the mobile node is connected to a trusted access network, then the home agent signals the fact that the connection is secure to the mobile node as part of the registration procedure, for example in the “binding acknowledgment” (v6) or “registration reply” (v4) message. In this case, a Mobile IPv6 node can use route optimization without encrypting all data packets, or the bi-directional tunnel does not need to be encrypted. A Mobile IPv4 node does not necessarily need to use reverse tunneling, and the Mobile IP tunnel does not need to be encrypted. It is to be noted that if new extensions to Mobile IP messages are needed to communicate this to the terminal (mobile node), then these extensions should be arranged so that if the terminal (mobile node) does not know these extensions, the terminal (mobile node) will still use encrypted and bi-directional tunneling. For example, the home agent may detect whether the terminal supports these extensions based on whether the terminal includes a certain extension in the registration request or binding update message. Advantageously, the type number of the extension is chosen so that a home agent that does not support the extension silently discards the extension, but processes the registration request or binding update message normally. If the home agent supports the extension, then the home agent includes another extension in the registration reply or binding acknowledgement message. If the terminal does not receive the extension, then the terminal knows that the home agent does not support the extension, and this feature will not be available.

The detection of the access network security can be effected according to the prior art solutions that use double mobility (as e.g. described in draft-ietf-mobileip-vpn-problem-solution-03.txt), where the terminal (mobile node) can detect whether it is “outside” or “inside” the trusted network by trying to register with both inner and outer home agents. A similar detection can also be used according to the present invention. For example, the home agent could have two separate addresses (internal and external), and the detection mechanism would be the same as in the above mentioned Internet-Draft. That is, the terminal (mobile node) tries to register with both home agents at the same time. If it gets a response from the “external” agent, then the terminal (mobile node) knows it is “outside”. If the terminal (mobile node) gets a response from the “internal” agent, then the terminal (mobile node) knows it is “inside”.

However, according to the present invention also only a single home agent can be used, so that alternatively to the above, a single home agent address could be used. In this case, the home agent could detect whether the terminal (mobile node) is “inside” or “outside” based on the sub-network interface from which the “binding update” or “registration request” was received, and possibly also based on the care-of address. If the “binding update” or “registration request” was received from a sub-network interface that is connected to the trusted sub-network, and if the care-of address is an address from the trusted sub-network, then the home agent knows the terminal (mobile node) is “inside” the trusted sub-network. If the “binding update”/“registration request” was received from a sub-network interface that is connected to a not trusted network, or if the care-of address is not an address of the trusted network, then the home agent determines that the terminal (mobile node) is “outside” the trusted network.

The advantages in this case are that there is no double tunneling or double mobility support necessary. Also, the terminal (mobile node) can move between trusted and not trusted access networks with the overhead of bi-directional tunneling and encryption being avoidable when connecting directly to a trusted network. In addition, the required changes or new extensions to the Mobile IP protocols are only minor, if any.

(Implementation Examples)

The present invention can be implemented as a VPN feature with a software implementation either in a VPN gateway node or in a VPN client (terminal/mobile node), or in both.

If the VPN gateway node can always determine the security properties of the current sub-network, then the client might not need much new implementation in addition to the IKE mobility enhancements. In this case, the client's policy would allow all the different cipher suites, and it would be the responsibility of the gateway node to ensure that only the appropriate cipher suites are used in each network.

Similarly, it is conceivable that the client would only be responsible of determining which cipher suites are acceptable in each network. In this case, the VPN gateway node would only need to support the basic IKE mobility enhancements or Mobile IP, assuming that security association re-negotiation is not combined with Mobile IP signaling.

It is also possible that both the client and the gateway try to ensure that the cipher suite used is appropriate for the current network.

(Fourth Embodiment)

The fourth embodiment of the present invention is related to reducing the handover latency when switching from a trusted to an untrusted network. According to the instant embodiment, this is achieved in that the mobile device negotiates an IPsec session with the IPsec gateway and puts the resulting Security Association “on hold”, i.e. the mobile device traffic is not processed with IPsec, while the mobile device resides in a trusted access, already while located in the trusted access network. When the mobile device detects that it has switched to an untrusted access it will inform the IPsec gateway of the change in IP address by using, for example, the MobIKE protocol. The mobile device will also enable the IPsec for all traffic from this point onwards.

(Implementation Example)

According to implementation examples of the fourth embodiment, it is considered that both in the VPN gateway and in the VPN client, VPN mobility extensions such as MobIKE are implemented. These VPN implementations allow the VPN session to remain valid even though there is no traffic.

In addition, the terminal can have a “mobility manager” software module that decides which network connection is used currently. When a trusted access network is available and preferred, then the mobility manager instructs the VPN client to maintain the VPN session from within the trusted network. One possibility is that mobility manager instructs the VPN client to establish a VPN session when the link quality of the current trusted network falls below a certain threshold. Even though the VPN tunnel is active, the mobility manager ensures that the default route for application traffic still goes via the trusted network. When the mobility manager detects that the application traffic should be sent via the VPN tunnel over a new IP network, for example because the trusted connection was lost or because a more preferred untrusted connection became available, then the mobility manager instructs the VPN client to register the new local address with the VPN gateway. The mobility manager then arranges the application traffic to be routed via the VPN tunnel.

Accordingly, the fourth embodiment of the present invention provides a fast handover between trusted and unstrusted access methods, i.e. it reduces the handover latency when switching from a trusted to an untrusted network.

According to the above description, disclosed is a method providing secure mobility for a terminal in a mobile system comprising at least two IP based sub-networks, comprising detecting a change of the IP based sub-network by the terminal; updating the connection parameters of the terminal so as to be connected with a new IP based sub-network; detecting security requirements of the new IP based sub-network; and adapting security associations of the terminal to the new IP based sub-network to the security requirements of the new IP based sub-network.

While it is described above what are presently considered as being preferred embodiments of the present invention, it is apparent to those skilled in the art that various modifications may be made without departing from the spirit and scope of the present invention as defined in the appended claims.

1. A method providing secure mobility for a terminal in a mobile system comprising at least two IP based sub-networks, the method comprising:
detecting a change of an IP based sub-network by the terminal;
updating connection parameters of the terminal so as to be connected with a new IP based sub-network;
detecting security requirements of the new IP based sub-network; and
adapting security associations of the terminal connected to the new IP based sub-network to the security requirements of the new IP based sub-network.

2. The method according to claim 1, wherein
the step of updating includes using Internet key exchange mobility extensions for updating an IP address of the terminal;
the step of detecting security requirements includes detecting, by one of the terminal and a gateway node, that security properties of the new IP based sub-network and an old IP based sub-network are different, and initiating a re-negotiation of the security associations according to a secure Internet Protocol using the Internet key exchange protocol; and
the step of adapting includes adapting, by one of the terminal and the gateway node, a list of allowed cipher suites according to the security requirements of the new IP based sub-network, and selecting a new cipher suite according to an adaptation of the secure Internet Protocol processing the security requirements of the new IP based sub-network.

3. The method according to claim 1, wherein
the step of updating includes performing a Mobile IP registration;
the step of detecting security requirements includes receiving indications in Mobile IP registration message extensions about allowed security associations and required security processing in the new IP based sub-network; and
the step of adapting includes adapting the security processing according to a secure Internet Protocol based on the Mobile IP registration message extensions.

4. The method according to claim 1, comprising the consecutive steps of:
negotiating an IPsec session with an IPsec gateway node by the terminal while the terminal is located in a trusted network;
detecting security requirements of an untrusted network;
detecting a change of an IP based sub-network by the terminal, wherein the change is from trusted access to untrusted access;
updating connection parameters of the terminal so as to be connected with a new IP based sub-network providing untrusted access; and
adapting security associations of the terminal connected to the new IP based sub-network to the security requirements of the new IP based sub-network including informing the IPsec gateway node of a change in an IP address of the terminal and enabling IPsec for all traffic.

5. A system comprising:
a terminal; and
a mobile system comprising at least two IP based sub-networks and a gateway node;
wherein the system is configured to
detect a change of an IP based sub-network by the terminal,
update connection parameters of the terminal so as to be connected with a new IP based sub-network,
detect security requirements of the new IP based sub-network, and
adapt security associations of the terminal connected to the new IP based sub-network to the security requirements of the new IP based sub-network.

6. The system according to claim 5, wherein the system is further configured to
update the connection parameters by using Internet key exchange mobility extensions for updating an IP address of the terminal;
detect security requirements by detecting, by one of the terminal and a gateway node, that security properties of the new IP based sub-network and an old IP based sub-network are different, and initiating a re-negotiation of the security associations according to a secure Internet Protocol using the Internet key exchange protocol; and
adapt security associations by adapting, by one of the terminal and the gateway node, a list of allowed cipher suites according to the security requirements of the new IP based sub-network, and selecting a new cipher suite according to an adaptation of the secure Internet Protocol processing the security requirements of the new IP based sub-network.

7. The system according to claim 5, wherein the system is further configured to
update connection parameters by performing a Mobile IP registration;
detect security requirements by receiving indications in Mobile IP registration message extensions about allowed security associations and required security processing in the new IP based sub-network; and
adapt security associations by adapting the security processing according to a secure Internet Protocol based on the Mobile IP registration message extensions.

8. The system according to claim 5, wherein the system is further configured to
negotiate an IPsec session with an IPsec gateway node by the terminal while the terminal is located in a trusted network;
detect security requirements of an untrusted network;
detect a change of an IP based sub-network by the terminal, wherein the change is from trusted access to untrusted access;
update connection parameters of the terminal so as to be connected with a new IP based sub-network providing untrusted access; and
adapt security associations of the terminal connected to the new IP based sub-network to the security requirements of the new IP based sub-network including informing the IPsec gateway node of a change in an IP address of the terminal and enabling IPsec for all traffic.

9. A gateway node of a mobile system, wherein the gateway node is configured to
detect a change of an IP based sub-network by the terminal,
update connection parameters of the terminal so as to be connected with a new IP based sub-network,
detect security requirements of the new IP based sub-network, and
adapt security associations of the terminal connected to the new IP based sub-network to the security requirements of the new IP based sub-network.

10. The gateway node according to claim 9, wherein the gateway node is further configured to update the connection parameters by using Internet key exchange mobility extensions for updating an IP address of the terminal;
detect security requirements by detecting, by the gateway node, that security properties of the new IP based sub-network and an old IP based sub-network are different, and initiating a re-negotiation of the security associations according to a secure Internet Protocol using the Internet key exchange protocol; and
adapt security associations by adapting, by the gateway node, a list of allowed cipher suites according to the security requirements of the new IP based sub-network, and selecting a new cipher suite according to an adaptation of the secure Internet Protocol processing the security requirements of the new IP based sub-network.

11. The gateway node according to claim 9, wherein the gateway node is further configured to
update connection parameters by performing a Mobile IP registration;
detect security requirements by receiving indications in Mobile IP registration message extensions about allowed security associations and required security processing in the new IP based sub-network; and
adapt security associations by adapting the security processing according to a secure Internet Protocol based on the Mobile IP registration message extensions.

12. The gateway node according to claim 9, wherein the gateway node is an IPsec gateway node and further configured to
negotiate an IPsec session with the terminal while the terminal is located in a trusted network; and
adapt security associations of the terminal connected to a new IP based sub-network providing untrusted access to the security requirements of the new IP based sub-network including informing the IPsec gateway node of a change in an IP address of the terminal and enabling IPsec for all traffic.

13. A terminal configured to change a connection between IP based sub-networks of a mobile system, and configured to
detect a change of an IP based sub-network by the terminal,
update connection parameters of the terminal so as to be connected with a new IP based sub-network,
detect security requirements of the new IP based sub-network, and
adapt security associations of the terminal connected to the new IP based sub-network to the security requirements of the new IP based sub-network.

14. The terminal according to claim 13, wherein the terminal is further configured to
update the connection parameters by using Internet key exchange mobility extensions for updating an IP address of the terminal;
detect security requirements by detecting, by one of the terminal and a gateway node, that security properties of the new IP based sub-network and an old IP based sub-network are different, and initiating a re-negotiation of the security associations according to a secure Internet Protocol using the Internet key exchange protocol; and
adapt security associations by adapting, by one of the terminal and the gateway node, a list of allowed cipher suites according to the security requirements of the new IP based sub-network, and selecting a new cipher suite according to an adaptation of the secure Internet Protocol processing the security requirements of the new IP based sub-network.

15. The terminal according to claim 13, wherein the terminal is further configured to
update connection parameters by performing a Mobile IP registration;
detect security requirements by receiving indications in Mobile IP registration message extensions about allowed security associations and required security processing in the new IP based sub-network; and
adapt security associations by adapting the security processing according to a secure Internet Protocol based on the Mobile IP registration message extensions.

16. The terminal according to claim 13, wherein the terminal is further configured to
negotiate an IPsec session with an IPsec gateway node by the terminal while the terminal is located in a trusted network;
detect security requirements of an untrusted network;
detect a change of an IP based sub-network by the terminal, wherein the change is from trusted access to untrusted access;
update connection parameters of the terminal so as to be connected with a new IP based sub-network providing untrusted access; and
adapt security associations of the terminal connected to the new IP based sub-network to the security requirements of the new IP based sub-network including informing the IPsec gateway node of a change in an IP address of the terminal and enabling IPsec for all traffic.

17. A computer program product, comprising processor implementable instruction portions, wherein, when the computer program product is run on a computer, the following steps are performed:
detecting a change of an IP based sub-network by the terminal;
updating connection parameters of the terminal so as to be connected with a new IP based sub-network;
detecting security requirements of the new IP based sub-network; and
adapting security associations of the terminal connected to the new IP based sub-network to the security requirements of the new IP based sub-network.

18. The computer program product according to claim 17, wherein said computer program product comprises a software medium storing said processor implementable instruction portions.

19. The computer program product according to claim 17, wherein said computer program product is directly loadable into the internal memory of a computer.

20. A signal for carrying processor implementable instructions for controlling a computer to perform the following steps:
detecting a change of an IP based sub-network by the terminal;
updating connection parameters of the terminal so as to be connected with a new IP based sub-network;
detecting security requirements of the new IP based sub-network; and
adapting security associations of the terminal connected to the new IP based sub-network to the security requirements of the new IP based sub-network.
